(19) United States
(12) Patent Application Publication
(10) Pub. No.: US 2020/0065224 A1
(43) Pub. Date: Feb. 27, 2020

(54) CONTEXT-SENSITIVE DERIVATION OF RELATIONSHIPS AMONG PROGRAM-INTEGRATED INFORMATION MESSAGES

(71) Applicant: International Business Machines Corporation, Armonk, NY (US)

(72) Inventors: Denise M. Genty, Austin, TX (US); Corradino D. Jones, Austin, TX (US); Su Liu, Austin, TX (US); Yin Xia, Beijing (CN)

(21) Appl. No.: 16/106,495

(22) Filed: Aug. 21, 2018

(51) Int. Cl. G06F 11/36; G06F 9/54; G06F 11/30; G06F 8/33; G06F 17/28; G06F 17/30

(52) U.S. Cl. CPC G06F 11/3612; G06F 9/546; G06F 11/302; G06F 17/30994; G06F 17/289; G06F 17/30946; G06F 8/33

(57) ABSTRACT

A computer-implemented method includes generating tracking data based on monitoring at least one of a source code, a compiler, an interpreter, and a runtime of a computer program. A relationship type is detected of a relationship among a first message and one or more other messages in the computer program, based on the tracking data. The relationship is encapsulated into a context-derivation structure associated with each of the first message and the one or more other messages. The first message is translated into a world language by transmitting the first message and the context-derivation structure to a translation agent.

### BACKGROUND

The present invention relates to program-integrated information and, more specifically, to context-sensitive derivation of relationships among program-integrated information messages.

Program-integrated information (PII) is information that is built into a computer program and thus conveyed to the user during execution of the program. For instance, PII messages are text strings that appear in the interface of a program. PII translation refers to the translation of PII messages into a world language other than the world language for which the program was developed, such that the program can be effectively used across various languages. PII translation is one of the most important globalization tasks in the software industry because translation enables software to be developed efficiently, in a single language, and then used across the world in other languages.

Extraction of PII messages and translation of these messages are generally performed as distinct tasks. Each entry of a PII message is assigned a key, or reference link, within the program. The PII messages themselves are copied into a resource file known as a PII message file, along with a reference to the respective key. The PII message file is translated into one or more other languages, resulting in other PII message files for the program in other languages. Thus, when the program is run in a desired language other than its native language (i.e., its first language, or the language used in the program by the development team), the PII message file corresponding to the desired language is used, and each key in the program provides a link to the appropriate translated PII message, which is dynamically displayed in the program.

### SUMMARY

Embodiments of the present invention are directed to a computer-implemented method for deriving relationships among messages in a program. A non-limiting example of the computer-implemented method includes generating tracking data based on monitoring at least one of a source code, a compiler, an interpreter, and a runtime of a computer program. A relationship type is detected of a relationship among a first message and one or more other messages in the computer program, based on the tracking data. The relationship is encapsulated into a context-derivation structure associated with each of the first message and the one or more other messages. The first message is translated into a world language by transmitting the first message and the context-derivation structure to a translation agent.

Embodiments of the present invention are directed to a system for deriving relationships among messages in a program. A non-limiting example of the system includes a memory having computer-readable instructions and one or more processors for executing the computer-readable instructions. The computer-readable instructions include generating tracking data based on monitoring at least one of a source code, a compiler, an interpreter, and a runtime of a computer program. Further according to the computer-readable instructions, a relationship type is detected of a relationship among a first message and one or more other messages in the computer program, based on the tracking data. The relationship is encapsulated into a context-derivation structure associated with each of the first message and the one or more other messages. The first message is translated into a world language by transmitting the first message and the context-derivation structure to a translation agent.

Embodiments of the invention are directed to a computer-program product for deriving relationships among messages in a program, the computer-program product including a computer-readable storage medium having program instructions embodied therewith. The program instructions are executable by a processor to cause the processor to perform a method. A non-limiting example of the method includes generating tracking data based on monitoring at least one of a source code, a compiler, an interpreter, and a runtime of a computer program. Further according to the method, a relationship type is detected of a relationship among a first message and one or more other messages in the computer program, based on the tracking data. The relationship is encapsulated into a context-derivation structure associated with each of the first message and the one or more other messages. The first message is translated into a world language by transmitting the first message and the context-derivation structure to a translation agent.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a block diagram of a translation system according to some embodiments of the invention;

FIG. 2 is a flow diagram of a method of deriving relationships among program integrated information messages, according to some embodiments of the invention;

FIG. 3A is an example program interface including program integrated information messages;

FIG. 3B is an example instance of a context-derivation structure generated based on the example program interface of FIG. 3A, according to some embodiments of the invention;

FIG. 4A is another example program interface including program integrated information messages;

FIG. 4B is an example instance of a context-derivation structure generated based on the example program interface of FIG. 4A, according to some embodiments of the invention;

FIG. 5 is yet another example program interface including program integrated information messages; and

FIG. 6 is a block diagram of a computer system for implementing some or all aspects of the translation system, according to some embodiments of this invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two- or three-digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e., one, two, three, four, etc. The terms “a plurality” may be understood to include any integer number greater than or equal to two, i.e., two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, as discussed above, PII messages are generally translated outside the context of a program to enable efficient software development and translation. However, performing translation outside the context of the program can lead to ambiguities. PII translation is usually performed, either directly or indirectly, by machine translators, although human translators are sometimes used. In either case, translation ambiguity occurs when a phrase in one language translates to multiple phrases with distinct meanings in another language. Without contextual information regarding the phrase to be translated, it can be difficult to choose the correct translation in the case of a translation ambiguity, regardless of whether the translator is a person or a machine.

Turning now to an overview of the aspects of the invention, one or more embodiments of the invention address the above-described shortcomings of the prior art by providing a mechanism to derive relationships among PII messages and to encapsulate those relationships to preserve context for translation. Specifically, one or more context-derivation structures may be established, where each context-derivation structure correlates with a relationship type, and where each relationship type maps to a corresponding context-derivation structure. A message tracker may analyze the source code, compilation, and runtime of the program to determine display orders, GUI component orders, and message calling sequences. This data may enable relationships to be established and encapsulated into appropriate context-derivation structures.

The above-described aspects of the invention address the shortcomings of the prior art by improving upon software translation techniques. By providing a context for each PII message, that PII message can be better understood by a translator. When generating a translation, the translator may then do so with reference to the context, thus reducing or removing translation ambiguities.

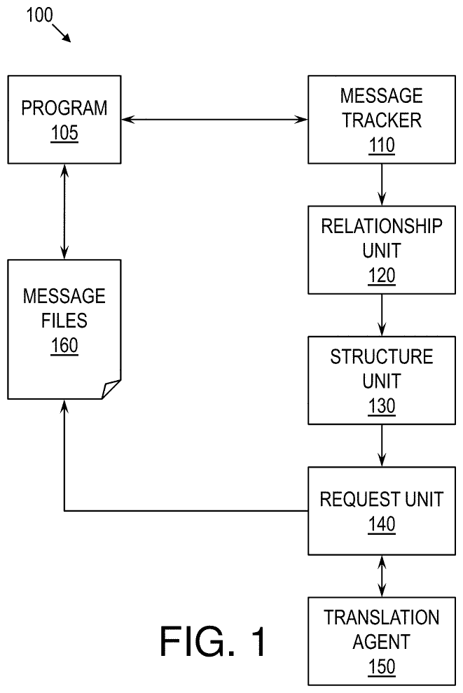

Turning now to a more detailed description of aspects of the present invention, FIG. 1 is a block diagram of a translation system 100 according to some embodiments of the invention. As shown in FIG. 1, the translation system 100 may include a message tracker 110, a relationship unit 120, a structure unit 130, a request unit 140, and a translation agent 150. Generally, the message tracker 110 may monitor a program 105 and thereby track the use of PII messages, also referred to herein simply as messages; the relationship unit 120 may detect relationships between messages based on the tracked usage; the structure unit 130 may select appropriate context-derivation structures for the messages; the request unit 140 may request translations of the messages, with each message associated with a corresponding context-derivation structure; and the translation agent 150 may translate the messages, utilizing the context-derivation structure of each message for reference. Generally, each of the message tracker 110, the relationship unit 120, the structure unit 130, the request unit 140, and the translation agent 150 may include hardware, software, or a combination of both. For instance, each of these components may be a software module or a specialized hardware device. Further, although these components are described herein as being distinct, this distinction is made for illustrative purposes only, and the message tracker 110, the relationship unit 120, the structure unit 130, the request unit 140, and the translation agent 150 may be combined in various ways or further divided based on design decisions.

The message tracker 110 may analyze various data associated with the program 105, such as the source code, compilation, interpretation, runtime, or a combination thereof. This monitoring may occur in real-time, such as when the compiler is running and when the program is executing, or the monitoring may involve receiving feedback about compilation and runtime after the fact, or a combination of both. For example, and not by way of limitation, the message tracker 110 may be or may include a daemon that operates within an integrated development environment (IDE) in which the program 105 is compiled and executed, where the daemon reports information about the program 105. In either case, the message tracker 110 may have access to source code data, which includes the source code of the program, runtime data, which includes information describing the runtime of the program 105, and compiler data, which includes information describing compilation or interpretation of the program 105.

From the source code data, the runtime data, and the compilation data, the message tracker 110 may generate tracking data. For instance, the tracking data generated by the message tracker 110 may include one or more of the following: display orders, graphical user interface (GUI) component orders, and message calling sequences. A display order is an order in which messages are displayed during execution of the program. A GUI component order is the order in which messages incorporated into GUI components of the program are displayed. Both of these may be determined through monitoring a user's interactions with the GUI during program execution. A message calling sequence is an order in which messages are extracted from a PII message file 160, also referred to herein simply as a message file 160, for insertion into the program 105. A message calling sequence need not be the same as a display order, for example, because the message calling sequence may be based on an order of prefetching that occurs prior to display of messages. As mentioned above, a message file 160 may maintain messages of the program 105 in a separate location from the program 105, to enable translation. Message calling sequences may be determined based on an examination of source code or based on monitoring of compilation or interpretation of the program 105.

The relationship unit 120 may utilize the determinations made by the message tracker 110 to determine relationships between messages. Specifically, for instance, the relationship unit 120 may select relationship types from among an established set of available relationship types, whose definitions are known to the translation system 100. To this end, the relationship unit 120 may utilize the display orders, GUI component orders, and message calling sequences to determine relationships between messages. For instance, display orders and GUI component orders can reveal the layout of messages in the program.

In some embodiments of the invention, the relationship unit 120 determines logical processing orders of messages, where each logical processing order is an order in which messages are selected by a user for processing during interaction with the program 105. For example, selection of a button reading “Submit,” where “Submit” is a PII message, in this case, can initiate submission of data the user has entered into a form. For another example, a user's sequence of selections through a nested drop-down menu hierarchy may constitute a logical processing order. Additionally, natural language processing may be applied to one or more of the display orders, GUI component orders, message calling sequences, and logical message processing orders to assist in determining relationships.

The structure unit 130 may encapsulate the messages in one or more context-derivation structures. There may be a pre-established set of context-derivation structures, designed to capture relationships between messages. Each context-derivation structure may be associated with a relationship type of a relationship that can exist among messages, and may encapsulate that relationship type. For example, and not by way of limitation, a context-derivation structure may be predefined for each of the following types of relationships: table, line, tree, star, ring, mesh, or other topology. In some embodiments of the invention, each context-derivation structure is implemented as a data structure, such as a class in object-oriented programming. One of skill in the art will understand how to define a data structure representing each of these relationship types, as well as others.

Based on the relationship type determined by the relationship unit 120, the structure unit 130 may select an appropriate context-derivation structure for a message and other messages with which it is related. Two or more messages may be grouped together within that context-derivation structure. If the context-derivation structure is implemented as a data structure, then to associate a set of messages with the context-derivation structure, the appropriate data structure may be instantiated, and the structure unit 130 may assign each message in the set to a variable within the resulting instance of the data structure as appropriate.

For instance, if the relationship unit 120 determines that a particular set of twenty messages together form a tree, then the context-derivation structure representing a tree may be selected for those twenty messages. Further, the hierarchy among those messages may be preserved through the manner in which the messages are arranged within the context-derivation structure. For instance, if a set of messages are deemed to form a tree, the assignment of variables within a context-derivation structure representing a tree may preserve the hierarchy of the tree. Analogously, for example, when messages appear on a command line, a context-derivation structure representing with a line relationship may be selected; and when messages are incorporated into a table in the program 105, then a context-derivation structure representing a table may be selected.

As needed, the request unit 140 may issue and manage translation requests, and the translation agent 150 may translate messages based on the context provided in the form of context-derivation structures. For example, the translation agent 150 may request messages for translation from the request unit 140. The request unit 140 may thus send the messages identified as existing in the program 105, as well as the context-derivation structures encapsulating the relationships among the messages. For another example, the request unit 140 may have been instructed to translate the program 105. As such, the request unit 140 may transmit the messages and instantiated context-derivation structures to the translation agent 150. In either case, the translation agent 150 may translate the messages, based on the contexts retained through the use of the context-derivation structures, and the translation agent 150 may return translations to the request unit 140. The translation agent 150 may be, for example, a person or an automated translation service capable of utilizing the context provided in the context-derivation structures. After the translation is performed, either the request unit 140 or the translation agent 150 may store the translations in a message file 160, so that the translations are accessible when the program 105 runs.

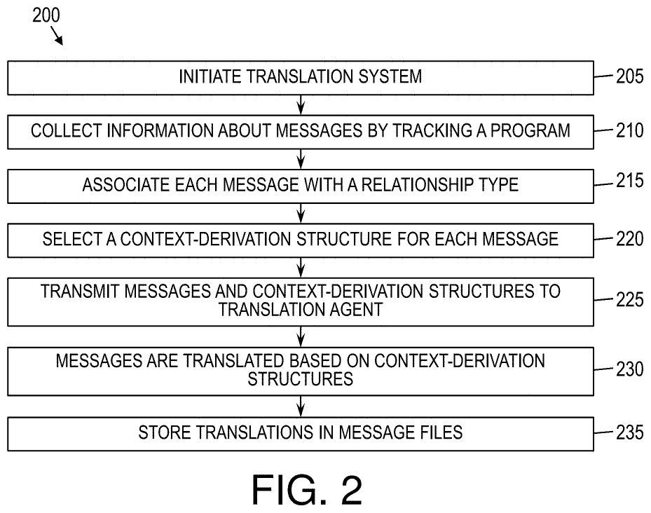

FIG. 2 is a flow diagram of a method 200 of deriving relationships among PII messages, according to some embodiments of the invention. As shown in FIG. 2, at block 205, the translation system 100 may be initiated to translate a program 105. For example, and not by way of limitation, initiation may occur within an IDE or may occur elsewhere, such as at a command prompt. For further example, initiation may come in the form of clicking on a start button or an icon representing the translation system 100 and providing a reference to the program 105, or initiation may occur by running an executable of the translation system 100 on a command line, with a reference to the program 105 included as an argument. It will be understood by one skilled in the art that many mechanisms can be used to initiate the translation system 100 and to indicate a desire to translate the program 105 specifically. In some embodiments of the invention, before initiation of the translation system 100, one or more message files 160 have already been established for the program 105. These messages files may include the various messages in the program 105 in at least one language, along with an associated key or other identifier for each, enabling each message to be associated with its appropriate placement in the program 105.

At block 210, the message tracker 110 of the translation system 100 may collect information about messages in the program 105. This information may be collected from tracking one or more of the following: source code of the program 105, compilation of the program 105, interpretation of the program 105, and runtime of the program 105. Specifically, the message tracker 110 may determine one or more of the following through the tracking: message display orders, GUI component orders, and message calling sequences.

At block 215, the relationship unit 120 may associate each message in the program 105 with a relationship type. Generally, the relationship type may classify a relationship that exists between the message in question and one or more other messages. In some embodiments of the invention, the relationship unit 120 may consider each message in the message files 160 associated with the program 105 and may determine a relationship type for each.

Based on the orders determined by message tracker 110, the relationship unit 120 may determine logical message processing orders, each of which is an order in which messages are selected by a user (e.g., during interaction with the program) for processing. Relationships may be discovered based on the data determined by the message tracker 110 (e.g., display orders, GUI component orders, message calling sequences) or based on the logical processing orders, or based on a combination of both. For example, and not by way of limitation, message display orders, GUI component orders, and message calling sequences can convey information about the layout of messages within an interface of the program 105. For instance, messages that makeup text in a drop-down box may be displayed only after a user selects that drop-down box, and those messages may be displayed in the order in which they appear in the drop-down box. Additionally, in some embodiments of the invention, the relationship unit 120 may use natural language processing to analyze the meaning of the display orders and GUI component orders, as the order of phrases can sometimes change the meaning of such phrases.

At block 220, for each message for which a relationship was determined, the structure unit 130 may select a context-derivation structure. Specifically, for instance, there may be a set of available relationships, and the relationship unit 120 may assign each message to one of such relationships and, further, may associate that message with other messages with which it shares that relationship. Each available relationship may correspond to a specific context-derivation structure. As such, if a relationship was determined for a message, then the context-derivation structure for that message may be the context-derivation structure to which that relationship correspond. The other messages sharing the relationship may likewise be associated with that relationship. If context-derivation structures are implemented as data structures, for example, then a reference to the message, such as a pointer the message or a value of the message, may be stored in an instance of the appropriate data structure, along with references to the messages sharing that relationship. The arrangement of the message and the other messages within the context-derivation structure may preserve the relationship of the messages in the program 105. For instance, if the message and the other messages form a tree with the message at the root of the tree, then within the context-derivation structure, the message would be saved as the root of the tree as well. Further, in some embodiments of the invention, the message and each other message stored in the instance of the data structure are associated with a reference to the instance, thus associating the message to the appropriate context-derivation structure.

It may be the case that no relationships are found for a message. In that case, that message may be encapsulated in a context-derivation structure that indicates the lack of relationships, or that message need not be associated with a context-derivation structure at all.

At block 225, each message may be transmitted to the translation agent 150 with reference to the context-derivation structure describing its relationship to other messages. At block 230, the translation agent 150 may translate the various messages of the program 105, given the context encapsulated in the context-derivation structures. At block 235, the translations of the messages may be stored in one or more message files 160 for later extraction when running the program 105.

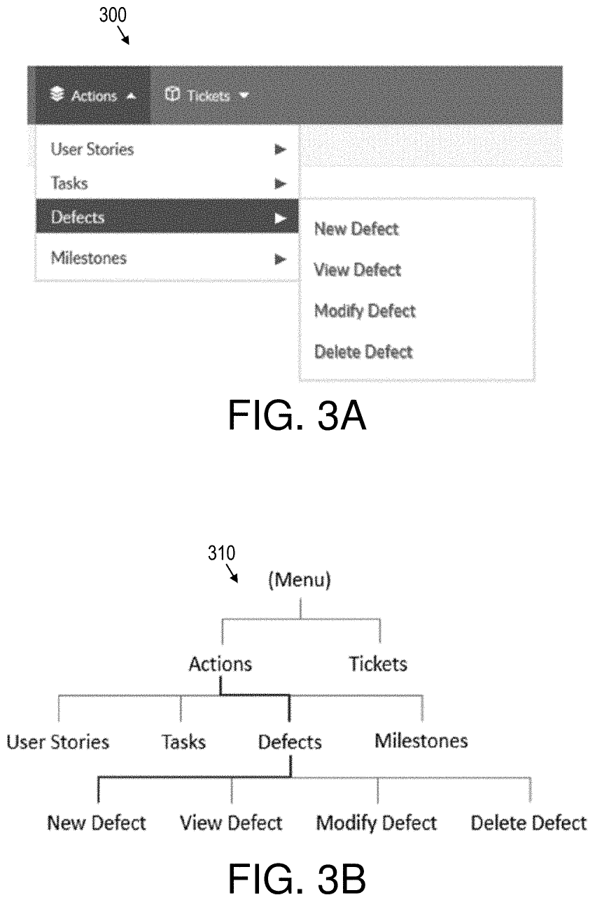

FIG. 3A is an example interface 300 of a program 105 that includes PII messages to be translated. In this example, the messages shown are “Actions,” “User Stories,” “Tasks,” “Defects,” “New Defect,” “View Defect,” “Modify Defect,” “Delete Defect,” “Milestones,” and “Tickets.” The user's interaction with the interface 300 has caused the following display order of these messages: “Actions,” “Tickets,” “User Stories,” “Tasks,” “Defects,” “Milestones,” “New Defect,” “View Defect,” “Modify Defect,” and then “Delete Defect.” This is the order in which the messages are shown, as certain messages are initially hidden until the user selects an item that initiates a box to drop down. Based on this display order, the translation system 100 may also determine that the logical processing order is as follows: “Actions” and then “Defect.” These are the messages selected by the user. As the user further explores this interface 300, additional display orders may be detected, where each display order provides information about nested drop-down menus. For instance, if the user selects “Tasks,” an additional drop-down menu will appear with additional messages added to the display order. Thus, the hierarchy of the drop-down menus is discernable.

FIG. 3B is an example instance of a context-derivation structure 310 generated based on the example program interface 300 of FIG. 3A, according to some embodiments of the invention. As shown, due to the hierarchies of drop-down boxes, made apparent in part by display orders, the relationship unit 120 may establish that the messages in this example are part of a tree hierarchy. Thus, the structure unit 130 may select a tree context-derivation structure 310. One of skill in the art will understand how to construct a data structure representing a tree, and such a data structure may be used as the tree context-derivation structure 310. An instance of this context-derivation structure 310 may be generated with references to the messages discussed above, and this instance may be associated with each of these messages. As such, when one of these messages is translated, the translator may have knowledge of the context surrounding the message.

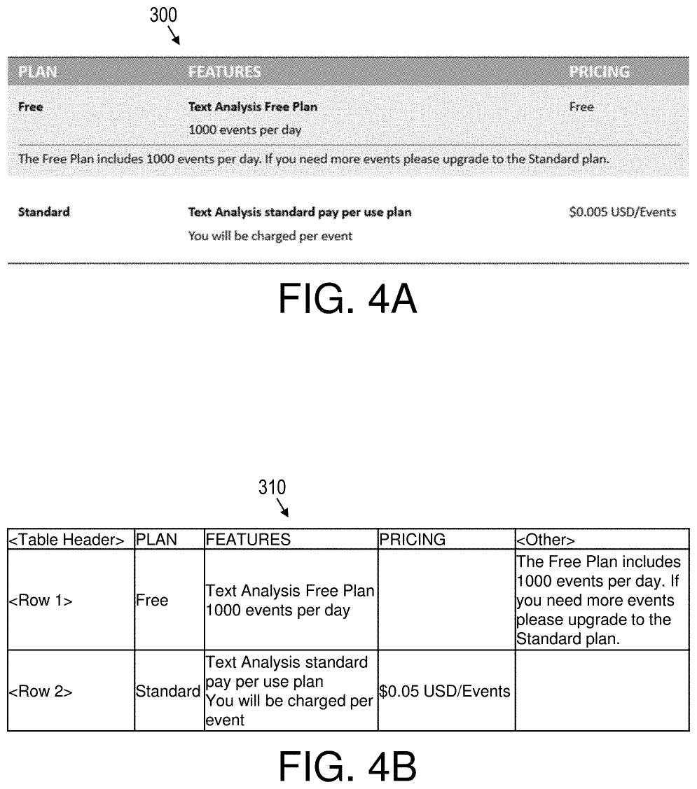

FIG. 4A is another example program interface 300 that includes messages for translation. In this example, the message tracker 110 identifies the following GUI component orders, which represent the rows of a table: {“PLAN,” “FEATURES,” “PRICING”}, {“Free,” “Text Analysis Free Plan 1000 events per day,” “Free,” “The Free Plan includes 1000 events per day. If you need more events please upgrade to the Standard plan.”}, and {“Standard,” “Text Analysis standard pay per use plan You will be charged per event,” “$0.05 USD/Events”}. Additionally, the message tracker 110 identifies the following GUI component orders, which represent the columns of the same table: {“PLAN,” “Free,” “Standard”}, {“FEATURES,” “Text Analysis Free Plan 1000 events per day,” “Text Analysis standard pay per use plan You will be charged per event”}, {“PRICING,” “Free,” “$0.05 USD/Events”}, and {“The Free Plan includes 1000 events per day. If you need more events please upgrade to the Standard plan.”}. In determining these GUI component orders, the message tracker 110 need not be aware that these messages are part of a table. However, the relationship unit 120 may determine, at least in part from the GUI component orders, that this is the case, due to the repetition of values in a manner that correlates with rows and columns.

FIG. 4B is an example instance of a context-derivation structure 310 generated based on the example program interface 300 of FIG. 4A, according to some embodiments of the invention. As shown in FIG. 4B, a context-derivation structure 310 representing a table may be selected by the structure unit 130, due to a determination by the relationship unit 120 that the messages form a table. One of skill in the art will understand how to construct a data structure representing a table, and such a data structure may be used as the table context-derivation structure 310. An instance of this context-derivation structure 310 may be generated with references to the messages discussed above, and this instance may be associated with each of such messages. As such, when one of these messages is translated, the translator may have knowledge of the context.

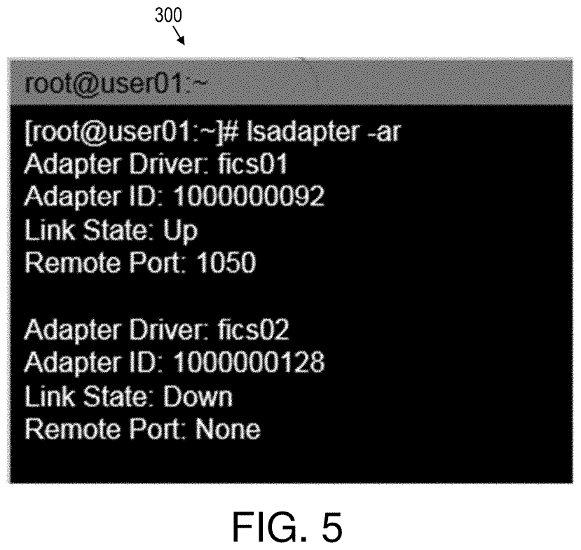

FIG. 5 is yet another example program interface 300 that includes messages to be translated. In this example, the message tracker 110 identifies the following display orders, among others, each of which represents a command line: {“Adapter Driver,” “fics01”}, {“Adapter ID,” “1000000092”},” {“Link State,” “Up”}, {“Remote Port,” “1050”}, {“Adapter Driver,” “fics02”}, {“Adapter ID,” “1000000128”},” {“Link State,” “Down”}, and {“Remote Port,” “None”}. Through analysis of the source code or runtime of the program 105, for example, the message tracker 110 may detect that a command line is being used and that each display order represents a command line. As such, the relationship unit 120 may determine that the relationship between the messages within each display order above is a line relationship. Thus, each such display order above may be encapsulated into a respective line context-derivation structure 310, which indicates the relationship between the messages within each line. For instance, when a translator sees that the messages “Up” and “Down” are each in a respective line relationship with “Link State,” this may enable the translator to understand that these messages “Up” and “Down” should be interpreted as “Connected” and “Disconnected” respectively.

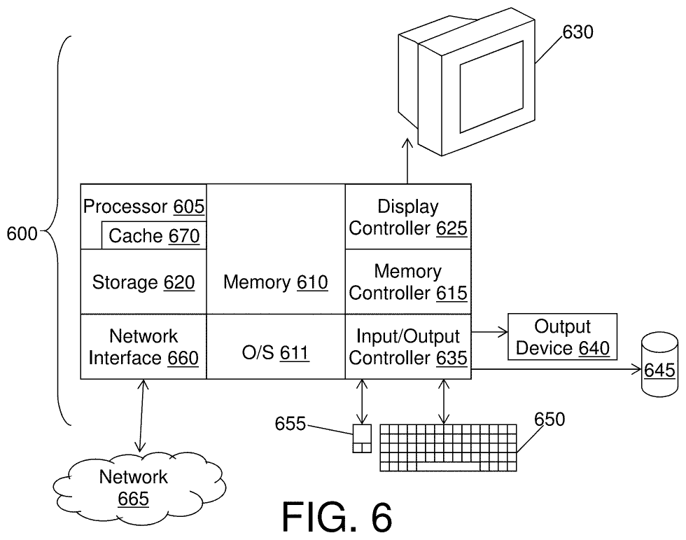

FIG. 6 is a block diagram of a computer system 600 for implementing some or all aspects of the translation system 100, according to some embodiments of this invention. The translation systems 100 and methods described herein may be implemented in hardware, software (e.g., firmware), or a combination thereof. In some embodiments, the methods described may be implemented, at least in part, in hardware and may be part of the microprocessor of a special or general-purpose computer system 600, such as a personal computer, workstation, minicomputer, or mainframe computer. For example, and not by way of limitation, each of the message tracker 110, the relationship unit 120, the structure unit 130, the request unit 140, and the translation agent 150 may reside and run on one or more computer systems 600.

In some embodiments, as shown in FIG. 6, the computer system 600 includes a processor 605, memory 610 coupled to a memory controller 615, and one or more input devices 645 and/or output devices 640, such as peripherals, that are communicatively coupled via a local I/O controller 635. These devices 640 and 645 may include, for example, a printer, a scanner, a microphone, and the like. Input devices such as a conventional keyboard 650 and mouse 655 may be coupled to the I/O controller 635. The I/O controller 635 may be, for example, one or more buses or other wired or wireless connections, as are known in the art. The I/O controller 635 may have additional elements, which are omitted for simplicity, such as controllers, buffers (caches), drivers, repeaters, and receivers, to enable communications.

The I/O devices 640, 645 may further include devices that communicate both inputs and outputs, for instance disk and tape storage, a network interface card (MC) or modulator/demodulator (for accessing other files, devices, systems, or a network), a radio frequency (RF) or other transceiver, a telephonic interface, a bridge, a router, and the like.

The processor 605 is a hardware device for executing hardware instructions or software, particularly those stored in memory 610. The processor 605 may be a custom made or commercially available processor, a central processing unit (CPU), an auxiliary processor among several processors associated with the computer system 600, a semiconductor-based microprocessor (in the form of a microchip or chip set), a macroprocessor, or other device for executing instructions. The processor 605 includes a cache 670, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 670 may be organized as a hierarchy of more cache levels (L1, L2, etc.).

The memory 610 may include one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 610 may incorporate electronic, magnetic, optical, or other types of storage media. Note that the memory 610 may have a distributed architecture, where various components are situated remote from one another but may be accessed by the processor 605.

The instructions in memory 610 may include one or more separate programs, each of which comprises an ordered listing of executable instructions for implementing logical functions. In the example of FIG. 6, the instructions in the memory 610 include a suitable operating system (OS) 611. The operating system 611 essentially may control the execution of other computer programs and provides scheduling, input-output control, file and data management, memory management, and communication control and related services.

Additional data, including, for example, instructions for the processor 605 or other retrievable information, may be stored in storage 620, which may be a storage device such as a hard disk drive or solid-state drive. The stored instructions in memory 610 or in storage 620 may include those enabling the processor to execute one or more aspects of the translation systems 100 and methods of this disclosure.

The computer system 600 may further include a display controller 625 coupled to a display 630. In some embodiments, the computer system 600 may further include a network interface 660 for coupling to a network 665. The network 665 may be an IP-based network for communication between the computer system 600 and an external server, client and the like via a broadband connection. The network 665 transmits and receives data between the computer system 600 and external systems. In some embodiments, the network 665 may be a managed IP network administered by a service provider. The network 665 may be implemented in a wireless fashion, e.g., using wireless protocols and technologies, such as WiFi, WiMax, etc. The network 665 may also be a packet-switched network such as a local area network, wide area network, metropolitan area network, the Internet, or other similar type of network environment. The network 665 may be a fixed wireless network, a wireless local area network (LAN), a wireless wide area network (WAN) a personal area network (PAN), a virtual private network (VPN), intranet or other suitable network system and may include equipment for receiving and transmitting signals.

Translation systems 100 and methods according to this disclosure may be embodied, in whole or in part, in computer program products or in computer systems 600, such as that illustrated in FIG. 6.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special-purpose hardware-based systems that perform the specified functions or acts or carry out combinations of special-purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A computer-implemented method comprising:
generating tracking data based on monitoring at least one of a source code, a compiler, an interpreter, and a runtime of a computer program;
detecting a relationship type of a relationship among a first message and one or more other messages in the computer program, based on the tracking data;
encapsulating the relationship into a context-derivation structure associated with each of the first message and the one or more other messages, wherein the context-derivation structure is a data structure, and wherein the encapsulating comprises arranging the first message and the one or more other messages in the context-derivation structure to preserve the relationship among the first message and the one or more other messages in the computer program and to preserve a hierarchy among the first message and the one or more other messages in the computer program; and
translating the first message into a world language by transmitting the first message and the context-derivation structure to a translation agent.

2. The computer-implemented method of claim 1, wherein the tracking data comprises at least one of a display order, a graphical user interface (GUI) component order, and a message calling sequence.

3. The computer-implemented method of claim 2, wherein:
the detecting the relationship type of the relationship among the first message and the one or more other messages in the computer program is based on the display order;
the display order is an order in which two or more messages are displayed within the computer program; and
the display order indicates the relationship among the first message and the one or more other messages.

4. The computer-implemented method of claim 2, wherein:
the detecting the relationship type of the relationship among the first message and the one or more other messages in the computer program is based on the GUI component order;
the GUI component order is an order in which two or more messages are displayed within a set of GUI components of the computer program; and
the GUI component order indicates the relationship among the first message and the one or more other messages.

5. The computer-implemented method of claim 2, wherein:
the detecting the relationship type of the relationship among the first message and the one or more other messages in the computer program is based on the message calling sequence;
the message calling sequence is an order in which two or more messages are extracted from a message file comprising a plurality of message for translation in computer program; and
the message calling sequence indicates the relationship among the first message and the one or more other messages.

6. The computer-implemented method of claim 1, wherein tracking is performed by a daemon in an integrated development environment in which the computer program executes.

7. The computer-implemented method of claim 1, further comprising selecting the context-derivation structure from among a plurality of available context-derivation structures, wherein each available context-derivation structure corresponds to an available relationship type, and wherein the selecting comprises mapping the relationship type to the context-derivation structure.

8. (canceled)

9. The computer-implemented method of claim 1, wherein the detecting the relationship type of the relationship among the first message and the one or more other messages in the computer program comprises detecting that the relationship type is at least one of a table, a line, a tree, a star, a ring, and a mesh.

10. A system comprising:
a memory having computer-readable instructions; and
one or more processors for executing the computer-readable instructions, the computer-readable instructions comprising:
generating tracking data based on monitoring at least one of a source code, a compiler, an interpreter, and a runtime of a computer program;
detecting a relationship type of a relationship among a first message and one or more other messages in the computer program, based on the tracking data;
encapsulating the relationship into a context-derivation structure associated with each of the first message and the one or more other messages, wherein the context-derivation structure is a data structure, and wherein the encapsulating comprises arranging the first message and the one or more other messages in the context-derivation structure to preserve the relationship among the first message and the one or more other messages in the computer program and to preserve a hierarchy among the first message and the one or more other messages in the computer program; and
translating the first message into a world language by transmitting the first message and the context-derivation structure to a translation agent.

11. The system of claim 10, wherein the tracking data comprises at least one of a display order, a graphical user interface (GUI) component order, and a message calling sequence.

12. The system of claim 10, wherein tracking is performed by a daemon in an integrated development environment in which the computer program executes.

13. The system of claim 10, the computer-readable instructions further comprising selecting the context-derivation structure from among a plurality of available context-derivation structures, wherein each available context-derivation structure corresponds to an available relationship type, and wherein the selecting comprises mapping the relationship type to the context-derivation structure.

14. (canceled)

15. A computer-program product for deriving relationships among messages in a program, the computer-program product comprising a computer-readable storage medium having program instructions embodied therewith, the program instructions executable by a processor to cause the processor to perform a method comprising:
generating tracking data based on monitoring at least one of a source code, a compiler, an interpreter, and a runtime of a computer program;
detecting a relationship type of a relationship among a first message and one or more other messages in the computer program, based on the tracking data;
encapsulating the relationship into a context-derivation structure associated with each of the first message and the one or more other messages, wherein the context-derivation structure is a data structure, and wherein the encapsulating comprises arranging the first message and the one or more other messages in the context-derivation structure to preserve the relationship among the first message and the one or more other messages in the computer program and to preserve a hierarchy among the first message and the one or more other messages in the computer program; and
translating the first message into a world language by transmitting the first message and the context-derivation structure to a translation agent.

16. The computer-program product of claim 15, wherein the tracking data comprises at least one of a display order, a graphical user interface (GUI) component order, and a message calling sequence.

17. The computer-program product of claim 15, wherein tracking is performed by a daemon in an integrated development environment in which the computer program executes.

18. The computer-program product of claim 15, the method further comprising selecting the context-derivation structure from among a plurality of available context-derivation structures, wherein each available context-derivation structure corresponds to an available relationship type, and wherein the selecting comprises mapping the relationship type to the context-derivation structure.

19. (canceled)

20. The computer-program product of claim 15, wherein the detecting the relationship type of the relationship among the first message and the one or more other messages in the computer program comprises detecting that the relationship type is at least one of a table, a line, a tree, a star, a ring, and a mesh.
